(19) United States
(12) Patent Application Publication
(10) Pub. No.: US 2008/0000040 A1
(43) Pub. Date: Jan. 3, 2008

(54) DUCT CLEANING EQUIPMENT IMPROVEMENTS

(75) Inventor: Scott A. Peterson, Fort Worth, TX (US)

Correspondence Address: HITT GAINES P.C., P.O. BOX 832570, RICHARDSON, TX, 75083, US

(73) Assignee: Rotobrush International, LLC, Grapevine, TX (US)

(21) Appl. No.: 11/428,174

(22) Filed: Jun. 30, 2006

(51) Int. Cl. B08B 9/035; B08B 9/043

(52) U.S. Cl. 15/304

(57) ABSTRACT

Duct cleaning accessories for use with a heating/ventilation/air conditioning (HVAC) duct cleaning system having a vacuum source, a vacuum hose, a drive motor, a cleaning brush, and a driveshaft having a first driveshaft end. In one embodiment, the duct cleaning accessories comprise a flexible shaft and a vacuum nozzle. In a preferred embodiment, the flexible shaft is a flexible driveshaft extension having first and second driveshaft extension ends. The first driveshaft extension end is coupleable to the first driveshaft end and the second driveshaft extension end is coupleable to the cleaning brush. A method of manufacturing the accessories is also provided.

### TECHNICAL FIELD OF THE INVENTION

The present invention is directed, in general, to air duct cleaning system and, more particularly, to an improved co-axial vacuum nozzle and flexible drive shaft extension for duct cleaning brushes.

### BACKGROUND OF THE INVENTION

So called “house dust” is widely considered by experts to pose health hazards to persons with allergies, asthma, or respiratory disorders and diseases. House dust may contain dirt, textile fibers, pollen, hair, skin flakes, residue of chemical and household products, cat and dog dander, decaying organic matter, dust mites, bacteria, fungi, viruses, and a variety of other contaminants. Literally, pounds of house dust accumulate on vents and in ducts that comprise the ventilating systems of both residential and commercial buildings. This house dust is becoming increasingly more harmful as Americans spend a larger percentage of their waking hours indoors, often aggravating allergies of the inhabitants.

Modern heating/ventilating/air conditioning (HVAC) systems typically incorporate air filters either just prior to the circulation fan of the systems or in the return ductwork. However, most often these filters comprise fiberglass or similar media that are reasonably effective against large debris, but are often inadequate in removing fine particulate matter, such as dust, dander, etc., from the circulated air. However, such filters only address those particles in the air that pass through them after being returned from the living space. The filter does not affect dust and debris that is already present in the ducts downstream of the HVAC unit that may be disturbed by airflow and carried into the living space.

The current approach to the problem of debris in ventilation ducts has been to use a rotating brush at the end of a flexible vacuum hose that is fed into each duct from each register location. The rotating brush may be powered by a separate drive shaft that is advanced along with the vacuum hose. In older systems, an independent vacuum hose was connected only to the ductwork with a separate agitating device operated independently of the vacuum source. The hose is fed toward the outflow portion of the HVAC system to the limit of the hose length. Practically speaking, the hose or agitator is usually about 25 feet to 35 feet long. Because of long or limited accessibility ductwork, it has sometimes been necessary to make multiple entries along the duct system in order to completely clean the ducts. In any event, current duct systems often employ right-angle junctions which must be navigated by the brush and vacuum hose nozzle. Additionally, dense debris, e.g., sand, dislodged by the rotating brush may find its way to the bottom of the duct and avoid the vacuum effect to remove it from the duct.

Accordingly, what is needed in the art is an improved apparatus to enable the cleaning brush to navigate the right-angle turns of the ducts and better scavenge debris on the floor of the ducts.

### SUMMARY OF THE INVENTION

To address the above-discussed deficiencies of the prior art, the present invention provides, in one aspect, duct cleaning accessories for use with a heating/ventilation/air conditioning (HVAC) duct cleaning system having a vacuum source, a vacuum hose, a drive motor, a cleaning brush, and a driveshaft having a first driveshaft end. In one embodiment, the duct cleaning accessories comprise a flexible shaft and a vacuum nozzle. In a preferred embodiment, the flexible shaft is a flexible driveshaft extension having first and second driveshaft extension ends. The first driveshaft extension end is coupleable to the first driveshaft end and the second driveshaft extension end is coupleable to the cleaning brush. A method of manufacturing the accessories is also provided.

The foregoing has outlined preferred and alternative features of the present invention so that those skilled in the pertinent art may better understand the detailed description of the invention that follows. Additional features of the invention will be described hereinafter that form the subject of the claims of the invention. Those skilled in the pertinent art should appreciate that they can readily use the disclosed conception and specific embodiment as a basis for designing or modifying other structures for carrying out the same purposes of the present invention. Those skilled in the pertinent art should also realize that such equivalent constructions do not depart from the spirit and scope of the invention.

### BRIEF DESCRIPTION OF THE DRAWINGS

For a more complete understanding of the invention, reference is now made to the following descriptions taken in conjunction with the accompanying drawing, in which:

FIG. 1 illustrates an exploded, partial sectional system view of a heating/ventilation/air conditioning (HVAC) duct cleaning system employing duct cleaning accessories constructed according to the principles of the present invention;

FIG. 2A illustrates an exploded, partial sectional view of one embodiment of a portion of the vacuum hose, the driveshaft, and the vacuum hose nozzle;

FIG. 2B illustrates an exploded, partial sectional view of an alternative embodiment of the accessories constructed according to the principles of the present invention;

FIG. 3 illustrates an exploded, partial sectional view of the first driveshaft end, the vacuum nozzle, the flexible shaft extension and the cleaning brush of FIG. 2B;

FIG. 4 illustrates an elevation view of a conventional HVAC duct and a conventional cleaning brush and vacuum nozzle coupled to a conventional drive shaft;

FIGS. 5A and 5B illustrate plan views of a conventional HVAC duct, vacuum hose, cleaning brush and drive shaft that is equipped with the vacuum nozzle and flexible shaft extension of the present invention before and after turning a corner in a duct;

FIG. 6 illustrates a plan view of the conventional HVAC duct, vacuum hose, cleaning brush and drive shaft that is equipped with the vacuum nozzle and flexible shaft extension of the present invention as the brush and hose assembly are being withdrawn from the duct;

FIG. 7A illustrates an elevation view of the conventional HVAC duct, vacuum hose, cleaning brush and drive shaft that is equipped with the vacuum nozzle and flexible shaft extension of the present invention as the brush and hose assembly is stopped and vacuuming the duct; and

FIG. 7B illustrates an elevation view of the conventional HVAC duct, vacuum hose, cleaning brush and drive shaft that is equipped with the vacuum nozzle and flexible shaft extension of the present invention as the brush and hose assembly is rotating and vacuuming the duct.

### DETAILED DESCRIPTION

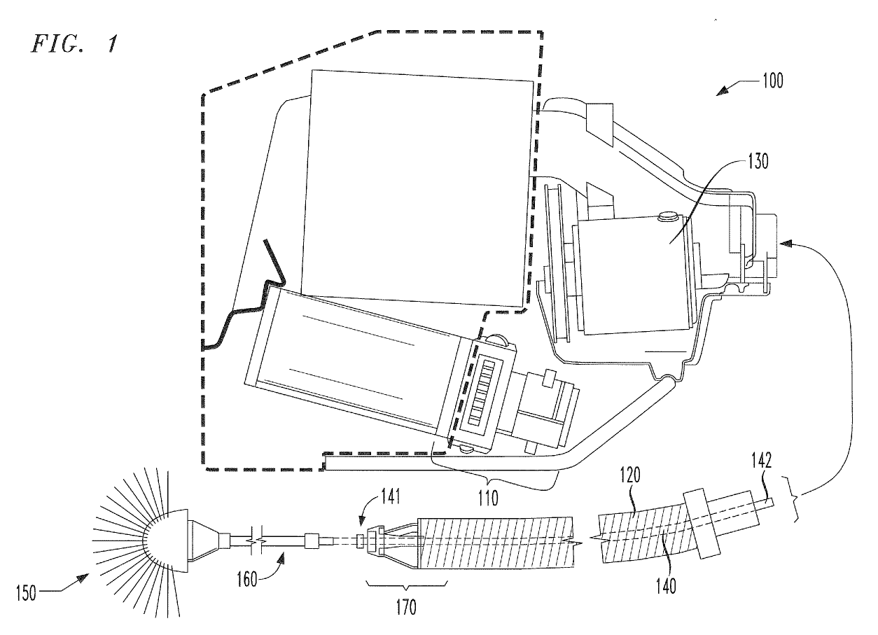

Referring initially to FIG. 1, illustrated is an exploded, partial sectional system view of a heating/ventilation/air conditioning (HVAC) duct cleaning system 100 employing duct cleaning accessories constructed according to the principles of the present invention. The HVAC duct cleaning system 100 has a vacuum source 110, a vacuum hose 120, a drive motor 130, a driveshaft 140, and a cleaning brush 150. The duct cleaning accessories comprise a flexible shaft extension 160 and a vacuum hose nozzle 170. In a preferred embodiment, the vacuum hose 120 is coupled to the vacuum source 110. The driveshaft 140 has a first driveshaft end 141 that is normally coupleable to the cleaning brush 150 and a second driveshaft end 142 coupleable to the drive motor 130. However, in the present embodiment, the flexible shaft extension 160 is interposed the first driveshaft end 141 and the cleaning brush 150. In the illustrated embodiment, the driveshaft 140 lies within the vacuum hose 120. Both the vacuum hose 120 and the driveshaft 140 are flexible so as to snake through a ventilation duct system (not shown).

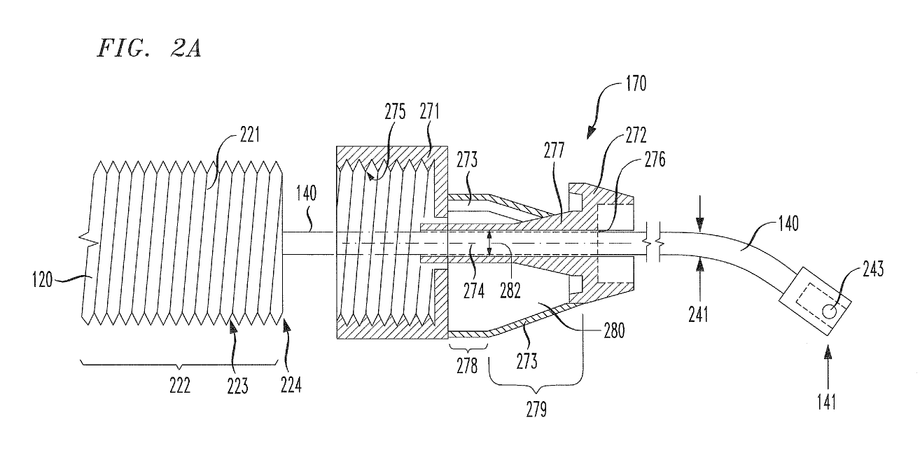

Referring now to FIG. 2A, illustrated is an exploded, partial sectional view of one embodiment of a portion of the vacuum hose 120, the driveshaft 140, and the vacuum hose nozzle 170. The vacuum hose nozzle 170 couples to a free end 224 of the vacuum hose 120. In a preferred embodiment, the vacuum hose 120 has an internal coil 221 that forms substantially male threads 222 on an outer surface 223 of the vacuum hose 120. These substantially male threads 222 extend to the free end 224 of the vacuum hose 120.

The vacuum nozzle 170 has a first collar 271, a second collar 272, a plurality of ribs 273 and a centerline 274. The first collar 271 comprises interior/female threads 275 configured to mate with the substantially male threads 222 of the vacuum hose 120. The second collar 272 has a central aperture 276 therethrough and a central sleeve 277 coupled to and extending from the second collar 272 along the centerline 274 toward the first collar 271. The driveshaft 140 extends through the central sleeve 277, the central aperture 276 such that at least a portion of the driveshaft 140 extends beyond the second collar 272. In a preferred embodiment, the driveshaft 140 may extend approximately six inches beyond the second collar 272. An outer diameter 241 of the driveshaft 140 is slightly smaller than an inner diameter 282 of the central aperture 276 and the central sleeve 277. Therefore, the driveshaft 140 is clear to rotate freely within the central aperture 276 and the central sleeve 277.

The plurality of ribs 273 couples the first collar 271 to the second collar 272 wherein each of the plurality of ribs 273 has a straight portion 278 and an angled portion 279. In a preferred embodiment, there are three ribs 273 (only two visible), thereby allowing significant rigidity to the second collar 272 while maximizing available void space 280 between the ribs 273 to enable vacuum pickup of dislodged debris. The straight portion 278 is substantially parallel to the centerline 274 of the vacuum nozzle 170. The angled portion 279 couples the straight portion 278 to the second collar 272.

Referring now to FIG. 2B, illustrated is an exploded, partial sectional view of an alternative embodiment of the accessories constructed according to the principles of the present invention. In this embodiment, the first driveshaft end 141 extends only sufficiently through the central sleeve 277 and the central aperture 276 to allow access for a tool (not shown) to be inserted through a driveshaft radial aperture 243 to a driveshaft extension retaining radial button 261.

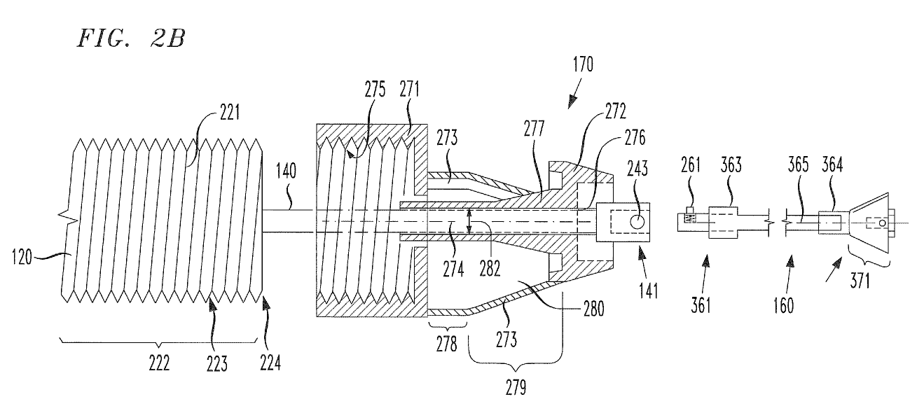

Referring now to FIG. 3, illustrated is an exploded, partial sectional view of the first driveshaft end 141, the vacuum nozzle 170, the flexible shaft extension 160 and the cleaning brush 150 of FIG. 2B. In one embodiment, the first driveshaft end 141 has driveshaft radial aperture 243 and a driveshaft longitudinal aperture 343. In a preferred embodiment, the flexible shaft extension 160 has first and second ends 361, 362, respectively, a first coupling 363, and a second coupling 364, wherein the first coupling has a longitudinal axis 365. In a preferred embodiment, the first and second couplings 363, 364 are quick connect couplings.

The first coupling 363 is affixed to the first end 361 and is configured to couple to the first driveshaft end 141. The first coupling 363 has spring-loaded, first coupling radial button 261 configured to engage the driveshaft radial aperture 243. The first coupling radial button 261 is depressable normal the first coupling longitudinal axis 365.

The second coupling 364 comprises a cone 371, a longitudinal aperture 372, a radial aperture 373, and a shoulder 374. The cone 371 comprises an axis of revolution 375 and a base 376. The shoulder 374 extends outwardly from the base 376 opposite from the cone 371.

In one embodiment, the cleaning brush 150 comprises a hub 350, a brush radial button 351, a backing plate 352, a dome 353, rivets 354, bristles 355 and staples 356. The bristles 355 may be secured to the dome 353 with the staples 356. The hub 350 and backing plate 352 may be formed from a single piece of material, e.g., aluminum. The brush radial button 351 is spring-loaded 357 and retained in the hub 350 by a crimp 358. The rivets 354 couple the backing plate 352 to the dome 353.

To couple the flexible shaft extension 160 to the first driveshaft end 141, the first coupling 363 is aligned with the driveshaft longitudinal aperture 343 and the first coupling radial button 366 is depressed with any suitable tool. The first coupling 363 is then slid longitudinally into the driveshaft longitudinal aperture 343 and the flexible shaft extension 160 rotated in place around the longitudinal axis 165 until the spring loaded, first coupling radial button 366 releases and engages the driveshaft radial aperture 342.

The second coupling 364 is affixed to the second end 362 and is configured to couple to the cleaning brush 150. The brush 150 is coupled to the second coupling 364 by aligning the brush hub 350 with the second coupling longitudinal aperture 372, depressing the brush radial button 351 with any suitable tool, sliding the hub 350 into the second coupling longitudinal aperture 372 and releasing the brush radial button 351. The brush 150 is then rotated in place around the longitudinal axis 365 until the brush radial button 351 releases and engages the second coupling radial aperture 373. The collar 374 allows sufficient clearance from the base 352 for heads of the rivets 354 to clear while the brush 150 is rotated. The brush 150 is detached from the second coupling 364 by depressing the brush radial button 351 with a suitable tool, e.g., small screw driver, pin punch, etc., and the brush 150 withdrawn. The flexible shaft extension 160 is detached from the first driveshaft end 141 by depressing the first coupling radial button 366 and withdrawing the flexible shaft extension 160.

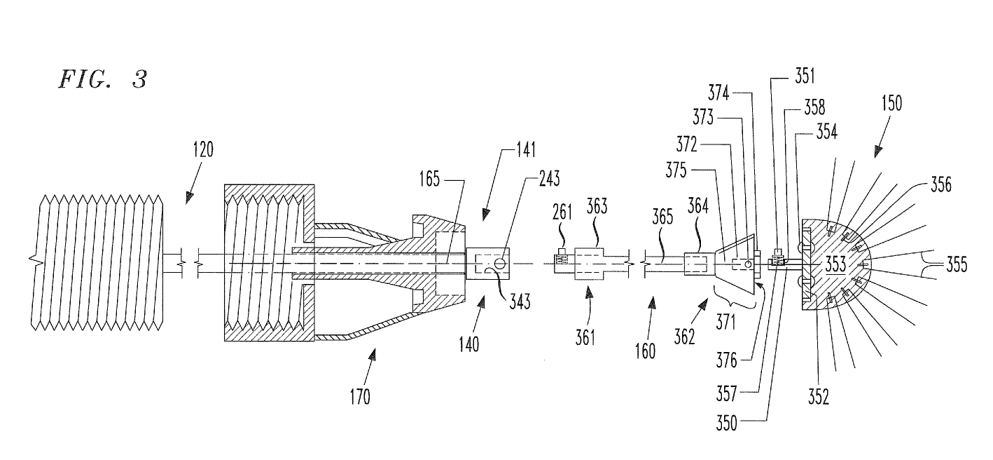

Referring now to FIG. 4, illustrated is an elevation view of a conventional HVAC duct 410 and a conventional cleaning brush 450 and vacuum nozzle 470 coupled to a conventional drive shaft 440. As can be seen, the brush 450, especially while rotating, will tend to lift the conventional vacuum nozzle 470 off of a lower surface 411 of the duct 410. By so doing, the nozzle 470 is raised away from the primary location, i.e., the lower surface 411, of debris 460 that it is intended to remove. The greater the distance that the vacuum nozzle 470 is from the lower surface 411; the stronger a vacuum source is needed to remove the debris 460.

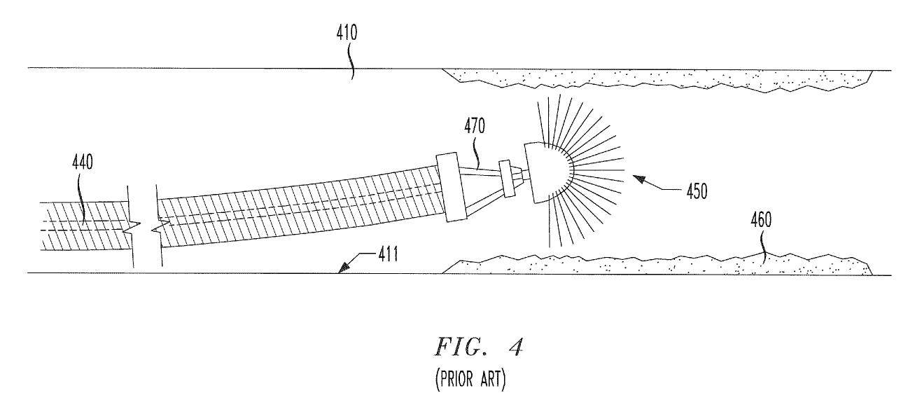

Referring now to FIGS. 5A and 5B, illustrated is a plan view of a conventional HVAC duct 510, vacuum hose 520, cleaning brush 550 and drive shaft 540 that is equipped with the vacuum nozzle 170 and flexible shaft extension 160 of the present invention. In a preferred embodiment, the flexible shaft extension 160 and the vacuum nozzle 170 would be used together. The HVAC duct 510 is shown to have a right angle turn 511 that can present problems to the operator in the navigation of the cleaning brush 550. Rotation of the brush 550 by the drive shaft 540 will cause the brush to favor either a left or right direction, depending upon the direction of rotation. Assuming the brush 550 is rotating in a direction that causes it to favor the right direction, the brush 550 will navigate the right angle corner 512 to proceed along section 511 of the duct 510 as in FIG. 5B. The flexible shaft extension 160 eases the turn for the brush 550 and the following vacuum hose 520 with drive shaft 540.

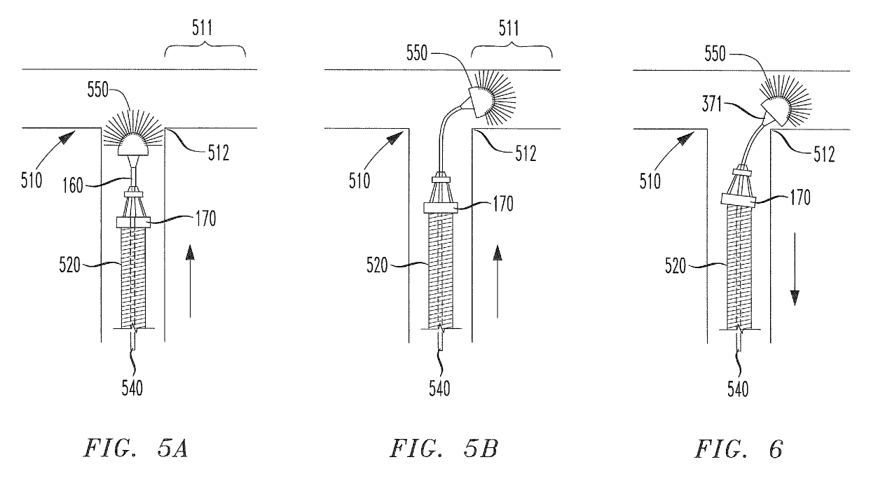

Referring now to FIG. 6, illustrated is a plan view of the conventional HVAC duct 510, vacuum hose 520, cleaning brush 550 and drive shaft 540 that is equipped with the vacuum nozzle 170 and flexible shaft extension 160 of the present invention as the brush 550 and hose 520 assembly are being withdrawn from the duct 510. The cone 371 of the flexible shaft extension 160 enables the withdrawal of the brush 550 with ease as the cone 371 contacts the right angle corner 512.

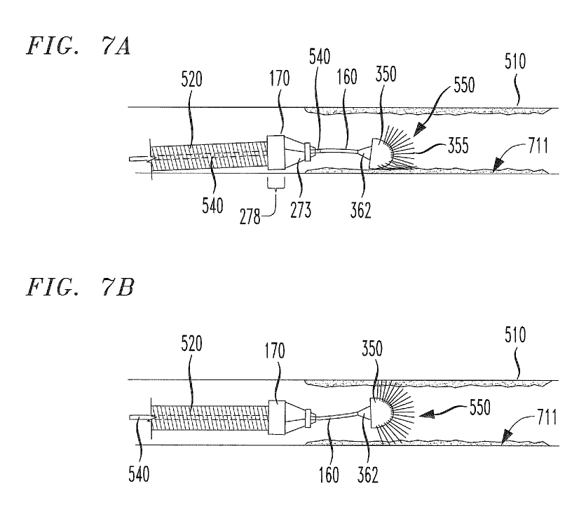

Referring now to FIG. 7A, illustrated is an elevation view of the conventional HVAC duct 510, vacuum hose 520, cleaning brush 550 and drive shaft 540 that is equipped with the vacuum nozzle 170 and flexible shaft extension 160 of the present invention as the brush 550 and hose 520 assembly is stopped and vacuuming the duct 510. When the brush 550 is not rotating, the lack of motion causes the weight of the second coupling 362 and the brush hub 350 to somewhat crush the bristles 355 of the brush 550, thereby allowing the vacuum nozzle to approach, and perhaps rest upon, a lower interior surface 711 of the duct 510. Additionally, the straight sections 278 of the ribs 273 are in close proximity, or even contact, with the lower interior surface 711. This brings the maximum amount of vacuum effect as closely as possible to the lower interior surface 711 where the debris generally collects when the brush 550 is not in motion.

Referring now to FIG. 7B, illustrated is an elevation view of the conventional HVAC duct 510, vacuum hose 520, cleaning brush 550 and drive shaft 540 that is equipped with the vacuum nozzle 170 and flexible shaft extension 160 of the present invention as the brush 550 and driveshaft 540 is rotating inside of the hose 520 and vacuuming the duct 510. When the brush 550 is rotating, the motion causes the weight of the second coupling 362 and the brush hub 350 to be lifted somewhat as the brush 550 spreads out in the duct 510. The vacuum nozzle 170 is also lifted, but the rise from the bottom of the duct is significantly less than when the flexible extension 160 is not used. Rotation can then be used to guide the brush through the duct 510. In this position, the vacuum is more effective against debris that is airborne within the duct 510 when the brush 550 is in motion. One who is of skill in the art will recognize that similar results will be obtained with the embodiment of FIG. 2A as with the embodiment of FIG. 2B.

Thus, accessories have been described for use with a heating/ventilation/air conditioning (HVAC) duct cleaning system having a vacuum source, a vacuum hose coupled to the vacuum source, a drive motor, a cleaning brush, a driveshaft having a first driveshaft end coupleable to the cleaning brush. The accessories include a flexible driveshaft extension with a cone proximate the cleaning brush so that the cleaning brush more easily traverses and returns from the duct system. Additionally, the accessories include a vacuum nozzle with an extended portion from a first collar the couples to the vacuum hose, the extended portion and the flexible driveshaft extension enabling the vacuum nozzle to more closely approach the bottom of a duct where the majority of debris collects.

Although the present invention has been described in detail, those skilled in the pertinent art should understand that they can make various changes, substitutions and alterations herein without departing from the spirit and scope of the invention in its broadest form.

What is claimed is:

1. For use with a heating/ventilation/air conditioning (HVAC) duct cleaning system having a vacuum source, a vacuum hose coupled to the vacuum source, a drive motor, and a cleaning brush, a duct cleaning accessory, comprising:
a vacuum nozzle having:
a first collar coupleable to a vacuum hose;
a second collar having a centerline and a central aperture therethrough; and
a plurality of ribs coupling said first collar to said second collar, each of said plurality of ribs having a straight portion and an angled portion, said straight portion substantially parallel to said centerline and extending at least a portion of said first collar, said angled portion coupled to said straight portion and said second collar; and
a driveshaft having a first driveshaft end coupleable to said cleaning brush and a second driveshaft end coupleable to said drive motor, said driveshaft extending through said central aperture wherein said first driveshaft end extends considerably beyond said second collar.

2. The duct cleaning accessory as recited in claim 1 further comprising a central sleeve coupled to and extending from said second collar toward said first collar, said driveshaft extending through said central sleeve.

3. The duct cleaning accessory as recited in claim 1 wherein said vacuum hose comprises an internal coil forming male threads on an outer surface of said vacuum hose, and further comprising female threads on an inner surface of said first collar, said female threads configured to mate with said male threads.

4. For use with a heating/ventilation/air conditioning (HVAC) duct cleaning system having a vacuum source, a vacuum hose, a cleaning brush, and a driveshaft having a first driveshaft end, a duct cleaning accessory, comprising:
a flexible driveshaft extension having first and second driveshaft extension ends, said first driveshaft extension end coupleable to said first driveshaft end and said second driveshaft extension end coupleable to said cleaning brush.

5. The duct cleaning accessory as recited in claim 4 further comprising a first coupling affixed to said first driveshaft extension end and configured to couple to said first driveshaft end.

6. The duct cleaning accessory as recited in claim 5 wherein said first coupling comprises a first radial button configured to engage a first radial aperture in said first driveshaft end.

7. The duct cleaning accessory as recited in claim 6 wherein said first coupling has a longitudinal axis and said first radial button is depressable normal said longitudinal axis.

8. The duct cleaning accessory as recited in claim 4 further comprising a second coupling affixed to said second driveshaft extension end and configured to couple to said cleaning brush

9. The duct cleaning accessory as recited in claim 8 wherein said second coupling comprises a cone having a base coupleable to said cleaning brush.

10. The duct cleaning accessory as recited in claim 8 wherein said second coupling comprises a longitudinal aperture configured to receive a hub of said cleaning brush.

11. The duct cleaning accessory as recited in claim 10 wherein said second coupling comprises a second radial aperture configured to engage a second radial button in said hub.

12. The duct cleaning accessory as recited in claim 8 wherein said second coupling further comprises a shoulder extending from said base.

13. For use with a heating/ventilation/air conditioning (HVAC) duct cleaning system having a vacuum source, a vacuum hose coupled to the vacuum source, a drive motor, a cleaning brush, and a driveshaft having a first driveshaft end coupleable to the cleaning brush, duct cleaning accessories, comprising:
a vacuum nozzle having:
a first collar coupleable to a vacuum hose;
a second collar having a centerline and a central aperture therethrough; and
a plurality of ribs coupling said first collar to said second collar, each of said plurality of ribs having a straight portion and an angled portion, said straight portion substantially parallel to said centerline and extending at least a portion of said first collar, said angled portion coupled to said straight portion and said second collar; and
a flexible shaft extension having first and second ends, said first end configured to couple to said first driveshaft end, and said second end configured to couple to said cleaning brush.

14. The duct cleaning accessories as recited in claim 13 wherein said flexible shaft extension has first and second couplings at said first and second ends, respectively, wherein said first and second couplings are quick-connect couplings.

15. The duct cleaning accessories as recited in claim 14 wherein said first coupling comprises a first radial button configured to engage a first radial aperture in said first driveshaft end.

16. The duct cleaning accessories as recited in claim 15 wherein said first coupling had a longitudinal axis and wherein said first radial button is depressable normal said longitudinal axis of said first coupling.

17. The duct cleaning accessories as recited in claim 14 wherein said second coupling comprises a cone having a base wherein said base is coupleable to said cleaning brush.

18. The duct cleaning accessories as recited in claim 17 wherein said second coupling further comprises a longitudinal aperture configured to receive a hub of said cleaning brush.

19. The duct cleaning accessories as recited in claim 17 wherein said second coupling comprises a second radial aperture configured to engage a second radial button in said hub.

20. The duct cleaning accessories as recited in claim 14 wherein said second coupling further comprises a shoulder extending from said base.

21. A method of manufacturing duct cleaning accessories for use with a heating/ventilation/air conditioning (HVAC) duct cleaning system having a vacuum source, a vacuum hose, a cleaning brush, and a driveshaft having a first driveshaft end, a duct cleaning accessory, comprising:
providing a flexible driveshaft extension having first and second driveshaft extension ends;
affixing a first coupling to said first end and configuring said first coupling to couple to said first driveshaft end; and
affixing a second coupling to said second end and configuring said second coupling to couple to said cleaning brush.

22. The method as recited in claim 21 wherein affixing said first and second couplings includes affixing quick-connect couplings.

23. The method as recited in claim 21 wherein affixing said first coupling includes affixing a first coupling having a first radial button configured to engage a first radial aperture in said first driveshaft end.

24. The method as recited in claim 23 wherein said first coupling has a longitudinal axis and wherein affixing a first coupling having a first radial button includes affixing a first radial button depressable normal said longitudinal axis of said first coupling.

25. The method as recited in claim 23 wherein affixing a first coupling having a first radial button includes affixing a spring-loaded button.

26. The method as recited in claim 21 wherein affixing said second coupling includes affixing a second coupling comprising a cone having a base wherein said base is coupleable to said cleaning brush.

27. The method as recited in claim 21 wherein affixing said second coupling includes affixing a second coupling comprising a longitudinal aperture configured to receive a hub of said cleaning brush.

28. The method as recited in claim 27 wherein affixing said second coupling includes affixing a second coupling comprising a second radial aperture configured to engage a second radial button in said hub.

29. The method as recited in claim 21 wherein affixing said second coupling includes affixing a second coupling further comprising a shoulder extending from said base.

30. The method as recited in claim 21 further comprising providing a vacuum nozzle having:
a first collar having a centerline and coupleable to said vacuum hose proximate said first driveshaft end;
a second collar having a central aperture therethrough, said first driveshaft end extending through said central aperture;
a plurality of ribs coupling said first collar to said second collar.
